(19) United States
(12) Patent Application Publication
(10) Pub. No.: US 2003/0066255 A1
(43) Pub. Date: Apr. 10, 2003

(54) Window assembly with glazing edge protection

(76) Inventor: Todd E. Cripe, Goshen, IN (US)

Correspondence Address: BANNER & WITCOFF LTD.,, ATTORNEYS FOR DURA AUTOMOTIVE, 28 STATE STREET - 28TH FLOOR, BOSTON, MA, 02109, US

(21) Appl. No.: 09/973,250

(22) Filed: Oct. 9, 2001

(51) Int. Cl. E06B 7/00; E06B 3/00

(52) U.S. Cl. 52/208; 52/204.591

(57) ABSTRACT

A window assembly includes an annealed laminated glazing having an inner surface, an outer surface, and a peripheral surface. The glazing has a first pane of annealed glass, a second pane of annealed glass, and a layer of laminating film sandwiched between the first and second panes. A frame member includes a base portion bonded to an inner surface of the glazing, and an edge portion extending along the peripheral surface of the glazing.

### FIELD OF THE INVENTION

The present invention relates to vehicle window assemblies, and more particularly to vehicle window assemblies providing protection for peripheral edges of glazing panels.

### BACKGROUND OF THE INVENTION

Window moldings are well known in the art to provide a sealing and decorative function around the peripheral edges of vehicle windows or glazings. Vehicle window glazings, other than windshields, are typically formed of tempered glass. Laminated annealed glass, which is not heat-treated and is susceptible to breakage along its peripheral edges, is typically used only in mass transit applications for glazings other than windshields.

U.S. Pat. No. 5,603,546 to Desir discloses a flush glass window molding that includes a base, a triangular shaped portion and a finger, all comprised of an extruded synthetic elastomeric material. The molding is adhesively bonded to the interior peripheral surface of a glazing panel such that the triangular shaped portion extends along the peripheral edge of the glazing panel, with the base of the triangular shaped portion being substantially parallel with the outer surface of the glazing panel. When the glazing is mounted in an opening of a vehicle body panel, the triangular shaped portion fills the gap between the glazing and the vehicle body panel, while the finger helps to locate the glazing in the opening. Such a molding is suitable for use only with tempered glass, since the elastomeric molding is not capable of significantly protecting the peripheral edge of the glazing. Further, the molding does not permit one glazing unit to abut a second glazing unit.

U.S. Pat. No. 5,154,028 to Hill discloses a flush mounted vehicle glazing in which a resin-based flexible mounting member is adhesively mounted to the inner surface of a glazing panel and extends along the peripheral edge of the glazing panel. Such a molding is suitable for use only with tempered glass, since the elastomeric molding is not capable of significantly protecting the peripheral edge of the glazing.

It is an object of the present invention to provide a window assembly that reduces or wholly overcomes some or all of the difficulties inherent in prior known devices. Particular objects and advantages of the invention will be apparent to those skilled in the art, that is, those who are knowledgeable or experienced in this field of technology, in view of the following disclosure of the invention and detailed description of certain preferred embodiments.

### BRIEF SUMMARY OF THE INVENTION

The principles of the present invention may be used advantageously to provide a window assembly that protects the peripheral edge or surface of a glazing panel, thereby allowing annealed laminated glass to be used in certain vehicle applications.

In accordance with a first aspect, a window assembly includes an annealed laminated glazing having an inner surface, an outer surface, a peripheral surface, and defining a plane. The glazing has a first pane of annealed glass, a second pane of annealed glass, and a layer of laminating film sandwiched between the first and second panes. A frame member includes a base portion bonded to the inner surface of the glazing, and an edge portion extending along the peripheral surface of the glazing.

In accordance with another aspect, a vehicle window assembly includes an annealed laminated glazing having an inner surface, an outer surface, a peripheral surface, and defines a plane. The glazing has a first pane of annealed glass, a second pane of annealed glass, and a layer of laminating film sandwiched between the first and second panes. A frame member includes a base portion bonded to the inner surface of the glazing, a flange extending inwardly from the base portion, an edge portion extending from the base portion along the peripheral surface of the glazing, and a skirt extending along at least a portion of a periphery of the glazing. The skirt extends from the edge portion substantially parallel to the plane of the glazing.

In accordance with another aspect, a vehicle window assembly includes at least two annealed laminated glazings. Each glazing has an inner surface, an outer surface, a peripheral surface, and defines a plane. Each glazing includes a first pane of annealed glass, a second pane of annealed glass, and a layer of laminating film sandwiched between the first and second panes. A frame member is secured to each glazing and has a base portion bonded to the inner surface of the glazing, an edge portion extending alone the peripheral surface of the glazing, and a skirt extending along at least a portion of a periphery of the glazing. The skirt extends from the edge portion substantially parallel to the plane of the glazing. A portion of the peripheral surface of each glazing is in close proximity to an adjacent glazing in an abutting relationship.

From this disclosure, it will be readily apparent to those skilled in the art, that is, those who are knowledgeable or experienced in this area of technology, that the present invention provides a significant advance. Preferred embodiments of the window assembly of the present invention provide improved edge protection for glazing panels, and the capability of centering the window assembly within a window opening, thereby easing assembly and reducing manufacturing costs. These and additional features and advantages of the invention disclosed here will be further understood from the following detailed disclosure of preferred embodiments.

### BRIEF DESCRIPTION OF THE DRAWINGS

FIG. 1 is a section view of a window assembly in accordance with a preferred embodiment of the present invention, showing a lower portion of the window assembly.

FIG. 2 is section view of an upper portion of the window assembly of FIG. 1, shown with a hinge attached to the window assembly.

FIG. 3 is a section view of an alternative embodiment of the hinge of FIG. 2.

FIG. 4 is a section view of an alternative embodiment of the window assembly of FIG. 1.

FIG. 5 is a section view of a side portion of the window assembly of FIG. 1, shown installed on a vehicle adjacent to a second window assembly.

### DETAILED DESCRIPTION OF THE INVENTION

It will be understood by those skilled in the art that the window assemblies disclosed and described herein are suitable for use in numerous applications, including for example, mass transit vehicles such as busses, or rail or subway cars. Further, these window assemblies can be rectangular or can be any other configuration required for the particular application. For purposes of illustration, various preferred and alternative features and aspects of the invention are now described in the context of rectangular windows.

In certain preferred embodiments, window assemblies in accordance with the present invention are flush mountable, that is, the window assembly is mounted such that the exterior surface of the window glazing is substantially flush with the exterior surface of the vehicle. Further, in preferred embodiments, the window is capable of being mounted such that a peripheral edge is in close proximity to and in parallel relationship with a peripheral edge of an adjacent window glazing. Additionally, the frame of the window may be a hidden frame, that is, the frame is substantially not visible from the exterior of the vehicle save for that portion that might be visible through the window glazing.

The window assembly is typically installed in a window opening defined by a body of a vehicle, such as a bus. A completed assembly can be mounted in the window opening, or can alternatively be installed in the window opening in parts, i.e., an incomplete assembly can be completed during installation. The vehicle body portions that define a rectangular window opening typically comprise a window opening header, a window opening footer, and two window opening jambs, as described below. In the illustrated embodiment, a frame member of a window assembly is formed of four segments, namely a top segment, a bottom segment and two side segments secured to one another to form a frame around a glazing panel.

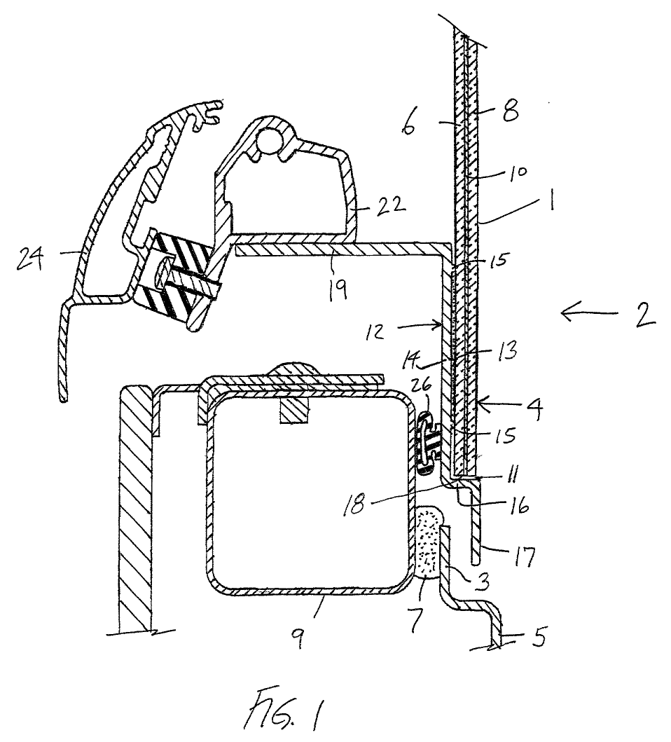

A bottom segment 1 of a window assembly 2 in accordance with a preferred embodiment, as seen in FIG. 1, includes a glazing panel or glazing 4. Glazing 4 is formed of annealed glass, and more preferably laminated annealed glass. Glazing 4 may, in certain preferred embodiments, be tinted to provide protection for the interior of the vehicle and its occupants. In other preferred embodiments, glazing 4 may be opaque. Window assembly 2 is mounted to the vehicle proximate a shoulder 3, defined by an outer skin 5 of the vehicle. Outer skin 5 is secured by an adhesive 7 to a structural member of the vehicle, such as window footer 9.

Glazing 4 includes an inner pane 6 and an outer pane 8, with a laminated film 10 extending and sandwiched between the two panes. Film 10 is preferably an elastomeric material, e.g., vinyl. Film 10 may be clear or tinted a desired color. The terms inner, interior, inward, inwardly, exterior, outer, outward, and outwardly, as used herein, refer to directions relative to the interior and exterior of a vehicle in which the window assembly is installed. Thus, in the illustrated embodiment, the exposed surface of inner pane 6 faces the interior of the vehicle when glazing 4 is installed in the vehicle, that is, to the left as seen in FIG. 1, and the exposed surface of outer pane 8 faces the exterior of the vehicle, that is, to the right as seen in FIG. 1.

A frame member 12 includes a base portion 14 and an edge portion 16. Base portion 14 is secured or bonded to an interior surface of inner pane 6 of glazing 4, preferably by adhesive 13. Base portion 14 extends substantially parallel to a plane defined by glazing 4. In certain preferred embodiments, one or more, and preferably two, spacers 15 are formed on an outer surface of base portion 14. Spacers 15 engage the exposed inner surface of inner pane 6 when frame member 12 is secured to glazing 4. Adhesive 13 is applied between spacers 15, and base portion 14 is attached to inner pane 6. Spacers 15 serve to contain adhesive 13, and to provide a gap between base portion 14 and inner pane 6, thus preventing adhesive 13 from being totally squeezed out as base portion 14 and pane 6 are secured to one another.

Spacers 15 may extend along the full length of frame member 12. Alternatively, they may contain gaps to permit excess adhesive to squeeze out. In certain preferred embodiments, spacers 15 are rails that extend along the outer surface of base portion 14. In other preferred embodiments, spacers 15 may be formed as protrusions. Other suitable shapes and configurations for spacers 15 will become readily apparent to those skilled in the art, given the benefit of this disclosure.

In certain preferred embodiments a primer layer is applied to inner pane 6 and base portion 14 before adhesive 13 is applied. Exemplary adhesives include urethane adhesives, moisture-activated urethanes, moisture-activated silicones, thermally-activated silicones, moisture-curable hot melt urethanes, thermally-activated modified epoxy, chemically-activated acrylate, and thermally-activated nitrile phenolic adhesives. [OTHER ADHESIVES?] Additional suitable adhesives will become readily apparent to those skilled in the art, given the benefit of this disclosure.

Edge portion 16 extends from one edge of base portion 14, along and in close proximity to a peripheral surface 18 of glazing 4 such that a gap 11 extends between edge portion 16 and peripheral surface 18. Gap 11 provides compensation for manufacturing tolerances, and is preferably minimized for aesthetic purposes. Edge portion 16 is preferably not directly secured to peripheral surface 18, that is, there is no adhesive or other bonding agent securing edge portion 16 to peripheral surface 18. However, a flexible sealant or caulking, e.g., silicone, may be inserted into gap 11 to provide a weatherproof seal.

In certain preferred embodiments, edge portion 16 extends substantially perpendicular to base portion 14 and the plane of glazing 4, and substantially parallel to peripheral surface 18. Edge portion 16 acts as a structural member to provide significant protection for peripheral surface 18 and the peripheral edges of inner panel 6 and outer panel 8 of glazing 4, and to trim the peripheral surface. Thus, edge portion 16 provides an edge to window assembly 2 that is safe to handle and visually appealing, giving a frameless appearance, that is, the appearance that there is no frame extending around the exterior of the window assembly. This is advantageous in that the glazing need not have a finished glass edge, thus reducing the cost of the glazing and making the use of annealed laminated glazings possible. Edge portion 16 also serves to locate the glazing into the window frame, centering the glazing and easing assembly.

Frame member 12 is preferably formed of a substantially rigid material, suitable for acting as a protective structural member, providing protection for peripheral surface 18 of glazing 4. Frame member 12, may be formed of materials such as plastic or metal, e.g., aluminum or steel.

In certain preferred embodiments, a skirt 17 extends from edge portion 16 along at least a portion of the periphery of glazing 4. Skirt 17 preferably extends substantially perpendicular to edge portion 16 and substantially parallel to the plane of glazing 4. In certain preferred embodiments, skirt 17 extends in the plane of glazing 4, that is, there is at least some overlap of skirt 17 and the plane of glazing 4. In certain preferred embodiments, the outer surface of skirt 17 is substantially flush with the outer surface of outer panel 8. Skirt 17 preferably extends such that it its end is in close proximity to outer skin 5.

In the embodiment illustrated in FIG. 1, window assembly 2 is an egress window that is capable of being opened to permit escape of passengers from the vehicle in case of emergency, but that in normal operation is latched tightly to provide a water tight seal and to reduce wind noise. A flange 19 extends inwardly from an end of base portion 14, remote from edge portion 16, to a latch housing 22 of a latch. Flange 19 may extend substantially perpendicular to base portion 14 and the plane of glazing 4. A release bar 24 of the latch within the interior of the vehicle is movable between a non-releasing down position, as seen here, and a releasing up position. Exemplary latches are shown in commonly assigned U.S. Pat. Nos. 5,787,643 to Schmuck and 5,941,022 to Schmuck, the entire disclosures of which are incorporated herein by reference for all purposes. Other suitable latches will become readily apparent to those skilled in the art, and further discussion of the latch need not be provided here.

A seal 26 is secured to an inner surface of base portion 14, preferably by adhesive. When window assembly 2 is in its closed position, seal 26 is compressed between base portion and window footer 9, thereby providing a weatherproof seal. Seal 26 is preferably formed of an elastomeric material, such as ethylene-propylene terpolymer (EPDM), or rubber, vinyl, or a closed-cell foam material. Other suitable materials for seal 26 will become readily apparent to those skilled in the art, given the benefit of this disclosure.

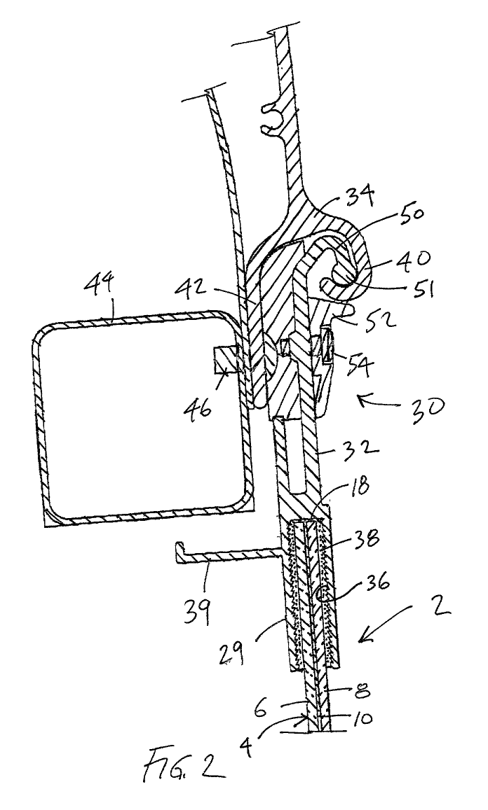

FIG. 2 illustrates a top segment 29 of the egress window embodiment of window assembly 2. A hinge 30 has a first portion 32 secured to glazing 4 and a second portion 34 secured to the vehicle. In certain preferred embodiments, second portion 34 may be unitary with the vehicle, that is, of one-piece construction with the vehicle. Hinge 30 acts to support window assembly 2 and permit it to be opened. In the illustrated embodiment, first portion 32 has a downwardly-opening U-shaped channel 36 that receives glazing 4. An adhesive 38 holds glazing 4 within channel 36. In the illustrated embodiment, channel 36 has a serrated surface to positively secure glazing 4 within channel 36. In other embodiments, channel 36 may have a smooth surface. Mounting flange 39 extends inwardly from first portion 32. Mounting flange 39 can be used to secure the side segments of window assembly 2 to the top and bottom segments of window assembly 2, as described in greater detail below.

Second portion 34 has a J-shaped hook portion 40 and a flange 42 that is secured to a window header 44 of the vehicle by way of a fastener 46. Fastener 46 may be a screw, bolt, rivet, adhesive or any other type of fastener adequate to secure second portion 34 to window header 44. First portion 32 has an inverted J-shaped hook portion 50 that engages hook portion 40. Hook portion 50 preferably has an end 51 that is rounded or cylindrical in shape. A hinge retainer 52 is secured to an outer surface of first portion 32 by way of a fastener, such as a screw 54. When glazing 4 is opened, hinge retainer 52 ensures that the window remains attached to the vehicle. Other suitable hinge designs will become readily apparent to those skilled in the art, given the benefit of this disclosure.

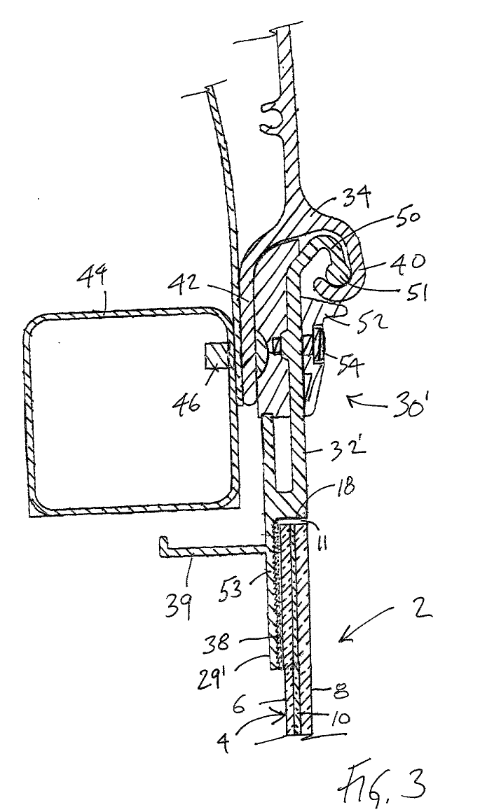

FIG. 3 illustrates top segment 29′ of an alternative egress window embodiment of window assembly 2. A flange 53 extends downwardly from first portion 32′ of hinge 30′. Inner pane 6 is secured to flange 53 with adhesive 38. The outer surface of flange 53 may be serrated to enhance the adherence of inner pane 6 to flange 53. Thus, in this embodiment, hinge 30′ is bonded to only a single surface of glazing 4, namely the inner surface of inner pane 6. In the illustrated embodiment, the outer surface of first portion 32′ is substantially flush with the outer surface of outer pane 8.

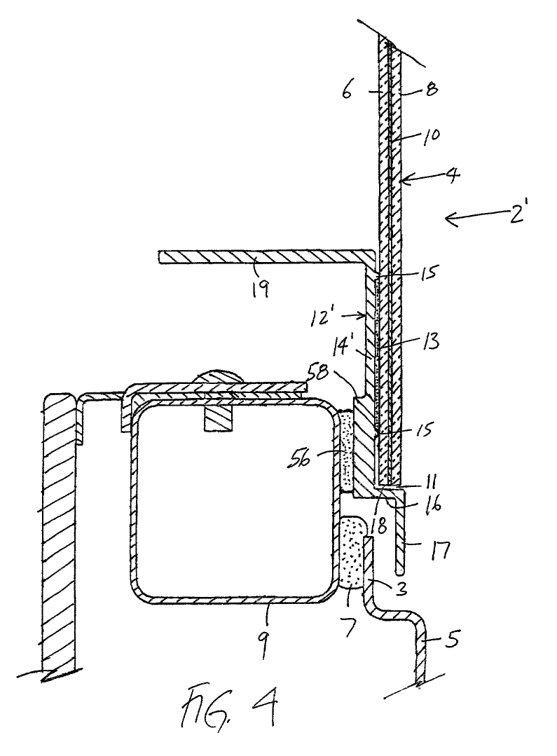

Another preferred embodiment is seen in FIG. 4, where a bottom segment 1′ of a non-egress, or bonded window assembly 2′ is shown. Frame member 12′ is directly secured to window footer 9 via adhesive 56. Base portion 14′ preferably has a thickened section 58 along a portion thereof to which adhesive 56 is applied. Thickened section 58 provides for proper spacing between frame member 12′ and the vehicle, and may provide additional strength for frame member 12′ at that point. Other elements of window assembly 2′ are identical to those described above with respect to window assembly 2 as seen in FIG. 1, and, therefore, the same reference numbers have been used for those elements. In this non-egress window embodiment, the top and side segments will have the same thickened portion as that shown here for the bottom segment.

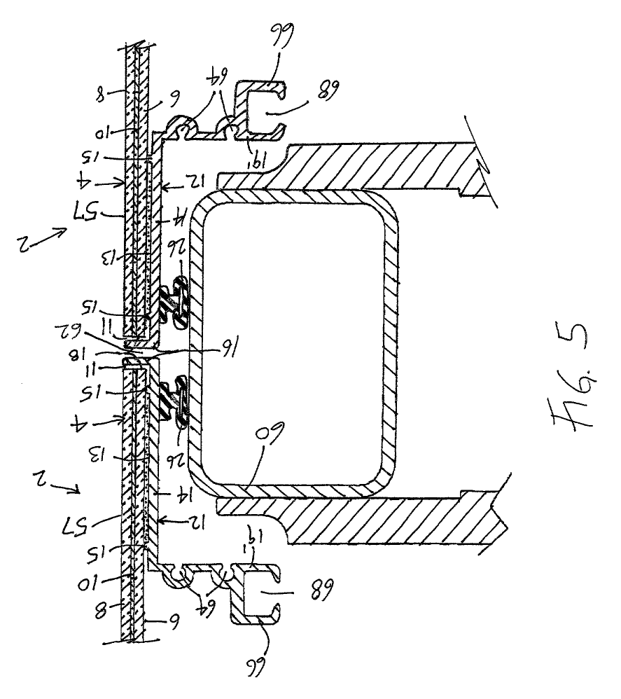

In other certain preferred embodiments, two or more window assemblies 2 may be mounted to a vehicle adjacent to one another, such as found on a bus. As seen in FIG. 5, where two side segments 57 of adjacent egress window assemblies 2 are illustrated, neither window assembly has a skirt on its frame member 12. Since this embodiment depicts an egress window, seals 26 are secured to the inner surface of base portions 14 and are compressed against a window jam 60 of the vehicle, providing weatherproof seals. The edge portions 16 of the two adjacent window assemblies are in close proximity to one another, providing a small gap 62 therebetween. It is to be appreciated that in a non-egress application, base portions 14 of the adjacent window assemblies 2 may be secured to the vehicle via adhesive, as described above with respect to FIG. 4.

Each flange 19′ includes at least one, and preferably a pair of channels 64, configured to receive fasteners (not shown), e.g., screws, that will secure a flange 39 of a top segment, as shown in FIG. 2, and a flange 19 of a bottom segment, as shown in FIG. 1, to the flange 19′ of the side segment illustrated here. A substantially C-shaped portion 66 defines a channel 68 that is exposed to the interior of the vehicle and receives a slidable blind to shield the passengers from the sun. Such an embodiment provides a flush look along the exterior of the vehicle, and a frameless appearance, as well as providing protection for the peripheral edges of the glazings.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

I claim:

1. A window assembly comprising;
an annealed laminated glazing having an inner surface, an outer surface, a peripheral surface, defining a plane and comprising:
a first pane of annealed glass;
a second pane of annealed glass; and
a layer of laminating film sandwiched between the first and second panes; and
a frame member comprising:
a base portion bonded to the inner surface of the glazing; and
an edge portion extending along the peripheral surface of the glazing.

2. The window assembly of claim 1, wherein the frame member further comprises a skirt extending along at least a portion of a periphery of the glazing, the skirt being connected to the edge portion and extending substantially parallel to the plane of the glazing.

3. The window assembly of claim 1, wherein the laminating film is formed of elastomeric material.

4. The window assembly of claim 1, wherein the frame member is formed of metal.

5. The window assembly of claim 1, wherein the frame member is formed of aluminum.

6. The window assembly of claim 1, wherein the frame member further comprises a flange extending inwardly from the base portion.

7. The window assembly of claim 1, wherein the frame member comprises a top segment, a bottom segment, and a pair of side segments, each segment including a flange extending inwardly from the base portion.

8. The window assembly of claim 7, wherein the flanges of the side segments include at least one channel configured to receive a fastener.

9. The window assembly of claim 1, further including a hinge comprising a first portion secured to the glazing and a second portion configured to be secured to a vehicle.

10. The window assembly of claim 9, wherein the first portion has a channel that receives a portion of the glazing.

11. The window assembly of claim 10, wherein the glazing is secured within the channel with adhesive.

12. The window assembly of claim 10, wherein the channel has a serrated surface.

13. The window assembly of claim 1, wherein the base portion is bonded to the inner pane with adhesive.

14. The window assembly of claim 1, further comprising a pair of spacers on an outer surface of the base portion, the spacers configured to maintain a gap between the base portion and the inner pane.

15. The window assembly of claim 1, further comprising a seal secured to an inner surface of the base portion, the seal configured to be compressed between the base portion and a vehicle in which the window assembly is installed.

16. The window assembly of claim 1, wherein the base portion includes a thickened portion configured to receive adhesive for securing the window assembly to a vehicle.

17. The window assembly of claim 1, further comprising a gap between the edge portion and the peripheral surface of the glazing.

18. A vehicle window assembly comprising;
an annealed laminated glazing having an inner surface, an outer surface, a peripheral surface, defining a plane and comprising:
a first pane of annealed glass;
a second pane of annealed glass; and
a layer of laminating film sandwiched between the first and second panes; and
a frame member comprising:
a base portion bonded to the inner surface of the glazing;
a flange extending inwardly from the base portion;
an edge portion extending from the base portion along the peripheral surface of the glazing, and
a skirt extending along at least a portion of a periphery of the glazing, the skirt extending from the edge portion substantially parallel to the plane of the glazing.

19. A vehicle window assembly comprising;
at least two annealed laminated glazings, each glazing having an inner surface, an outer surface, a peripheral surface, and defining a plane, each glazing comprising:
a first pane of annealed glass;
a second pane of annealed glass; and
a layer of laminating film sandwiched between the first and second panes; and
a frame member secured to each glazing comprising:
a base portion bonded to the inner surface of the glazing;
an edge portion extending along the peripheral surface of the glazing, and
a skirt extending along at least a portion of a periphery of the glazing, the skirt extending from the edge portion substantially parallel to the plane of the glazing,
wherein a portion of the peripheral surface of each glazing is in close proximity to an adjacent glazing in an abutting relationship.

20. The vehicle window assembly of claim 19, wherein each laminated glazing includes a seal secured to an inner surface of the base portion of the frame member, the seal configured to be compressed between the base portion and a vehicle in which the window assembly is installed.

21. The vehicle window assembly of claim 19, wherein at least one of the laminated glazings is an egress glazing having a hinge secured thereto.
